(19) United States
(12) Patent Application Publication
(10) Pub. No.: US 2015/0321208 A1
(43) Pub. Date: Nov. 12, 2015

(54) FLAVORING OR SWEETENING SPRAY DELIVERY SYSTEM

(71) Applicant: Armand Kramedjian, Atlanta, GA (US)

(72) Inventors: Armand Kramedjian, Atlanta, GA (US); Robert Davis, Roswell, GA (US)

(21) Appl. No.: 14/703,450

(22) Filed: May 4, 2015

Related U.S. Application Data
(60) Provisional application No. 61/989,835, filed on May 7, 2014.

(51) Int. Cl. B05B 11/00; A23L 1/00; B05B 1/02; A23L 1/236

(52) U.S. Cl. CPC B05B 11/3042; A23L 1/236; A23L 1/0061; B05B 1/02; A23V 2002/00

(57) ABSTRACT

A liquid delivery system is described. The liquid delivery system includes a nozzle sized and shaped to form a certain spray pattern to deliver, among other possible liquids, a liquid form of a flavoring agent or sweetener into another liquid or a food. In some examples, the nozzle may be shaped to provide a desired velocity of liquid. In other examples, the nozzle may be shaped to provide a desired spray pattern.

### RELATED APPLICATIONS

This application claims priority to Provisional Application No. 61/989,835, filed on May 7, 2014, entitled, “SWEET SPRAY”, the entire contents of which are incorporated herein by reference.

### BACKGROUND

Foods and liquids may be flavored or sweetened using various methods. A common way to sweeten (i.e. make or become sweet or sweeter in taste) is to use a packet of sweetener. A user will open the packet and disperse the contents of the packet on the food or liquid. An advantage of using a packetized form of sweetener can be its relatively small size, making transport and storage easier. However, in some cases, when placed in a liquid, some mechanical agitation needs to be used to cause the sweetener (in solid form) to fully mix with the liquid.

As an alternative to a packetized form of sweetener, a person may use a liquid form of sweetener. In some instances, one or more sweetening components are mixed with a liquid and placed in a delivery system, such as a bottle. A user pushes down on the bottle's pump, causing the liquid to be pulled (or pushed, depending on the bottle design) from the bottle and into the liquid. In some cases, additional mechanical agitation in the form of stirring may need to be employed to cause the sweetener to fully mix with the liquid.

It is with respect to these and other considerations that the disclosure herein is presented.

### SUMMARY

It should be appreciated that this Summary is provided to introduce a selection of concepts in a simplified form that are further described below in the Detailed Description. This Summary is not intended to be used to limit the scope of the claimed subject matter.

According to embodiments disclosed herein, a liquid delivery system is described. The liquid delivery system includes a nozzle shaped to form a certain spray pattern to deliver, among other possible liquids, a liquid form of a sweetener into another liquid or a food. In some examples, the nozzle may be shaped to provide a desired velocity of liquid. In other examples, the nozzle may be shaped to provide a desired spray pattern.

The features, functions, and advantages that have been discussed can be achieved independently in various embodiments of the present disclosure or may be combined in yet other embodiments, further details of which can be seen with reference to the following description and drawings.

### BRIEF DESCRIPTION OF THE DRAWINGS

The embodiments presented herein will become more fully understood from the detailed description and the accompanying drawings, wherein:

FIG. 1 is an illustration of a conventional liquid delivery system.

FIG. 2 is an illustration of a liquid delivery system having an increased velocity according to at least one embodiment disclosed herein.

FIGS. 3A and 3B are side view illustrations of exits ports according to at least one embodiment disclosed herein.

FIG. 4 are side view illustrations of liquid delivery systems having different velocities according to at least one embodiment disclosed herein.

FIG. 5 is a side view illustration showing different impact angles of a liquid according to at least one embodiment disclosed herein.

FIG. 6A is an illustration showing an alternative nozzle configured to provide a modified spray pattern according to at least one embodiment disclosed herein.

FIG. 6B is an illustration showing a semi-circular spray pattern caused by the alternative nozzle of FIG. 6A according to at least one embodiment disclosed herein.

FIG. 6C is an illustration showing a liquid delivery system using the alternative nozzle of FIG. 6A according to at least one embodiment disclosed herein.

FIG. 7 illustrates one configuration of a routine 700 for using a liquid delivery system according to at least one embodiment disclosed herein.

The plurality of figures presented in this application illustrates variations and different aspects of the embodiments of the present disclosure. Accordingly, the detailed description on each illustration will describe the differences identified in the corresponding illustration.

### DETAILED DESCRIPTION

The following detailed description is directed to technologies for a liquid delivery system. In various embodiments of the presently disclosed subject matter, the liquid delivery may include a vessel for storing liquid and a pump delivery system. The pump delivery system may include an intake tube for the uptake of liquid into a nozzle for eventual expulsion into a liquid. The nozzle may be sized and/or shaped to provide a certain spray pattern or velocity to the liquid upon exit from the nozzle.

A liquid delivery system may be used in conjunction with various solid foods or liquids, and/or containment vessels for holding those liquids. It should be noted that examples of the presently disclosed subject matter are discussed in relation to the application of a sweetening component into a liquid. However, the presently disclosed subject matter may be used in other ways. For example, various examples of the presently disclosed subject matter may be used to sweeten vegetables, fruits, breads, nuts, popcorn, and other food items.

In other examples, various implementations of the presently disclosed subject matter may provide for the application of flavoring agents to foods or liquids. For example, implementations may be used to add a flavoring agent such as a bacon-like taste to a food or liquid. For example, the flavoring agent (or component) may be an agent such as, but not limited to, a fruit flavoring, bacon flavorings, meat flavorings, vegetable flavorings, spices, herbs, chocolate, vanilla, salts, or various combinations thereof. In other example, implementations may be used to provide better dispersion of a flavoring agent. For example, some foods include crevices or voids that may not receive a powered or solid form of a flavoring agent or sweetener. In this example, implementations may be used to provide for a liquid that can cover a relatively larger surface area than what otherwise may be provided with a similar amount of a solid flavoring agent. In another example, the liquid flavoring agent (including salt) may be dispensed at a certain volume, providing for a lower degree of effort necessary to measure a proper amount of the flavoring agent in cooking. In some examples, the use of a spray versus other application technologies may increase the coverage of the sweetening component. And in further examples, may decrease waste or overspray. The listing of liquid forms of food in the presently disclosed subject matter is for purposes of illustration only.

The nozzle may be sized and shaped to provide for a better delivery of the sweetened liquid into a “target” liquid or onto a target solid or semi-solid food. For example, in some uses, the target liquid may have a relatively high surface tension. In some liquids, the top most layers experience a level of cohesion greater than the remaining layers of liquids. The tension of these top layers can act as a barrier to delivery of the sweetened liquid. In some examples, the tension is great enough that, when delivered to the target liquid, a larger portion of the sweetened spray will remain on top of the top most layers of the target liquid, forcing the person using the liquid sweetener to mechanical agitate the target liquid to force the sweetened liquid into the target liquid.

Some examples of the presently disclosed subject matter may utilize a nozzle having a shape and size to cause a desired velocity of the sweetened liquid. In some instances, the velocity may be such that a greater portion of the sweetened liquid is delivered to the lower layers of the target liquid, the layers in which a lower tension is typically exhibited. Delivery to these lower layers may reduce or eliminate the need for mechanical agitation. The velocity may be sufficient that the force of the drops of the sweetened liquid upon contact the top layers is great enough to “break through” the surface tension of the top layers.

In another example, the sweetened liquid may be delivered into a cup or other similar container. Conventional nozzles utilize pinhole openings to create a spray pattern. However, in some examples, the spray pattern or use may cause a portion of the sweetened liquid to be dispersed onto another surface other than the target liquid. For example, some of the spray may end up on the edge of the cup or outside of the cup. The nozzle may be sized and/or shaped to reduce or eliminate the amount of sweetened liquid that is not directly delivered to the target liquid.

These and some other aspects of the presently disclosed subject matter are described in further detail, below. In the following description, references are made to the accompanying drawings that form a part hereof, and which are shown by way of illustration, specific embodiments, or examples.

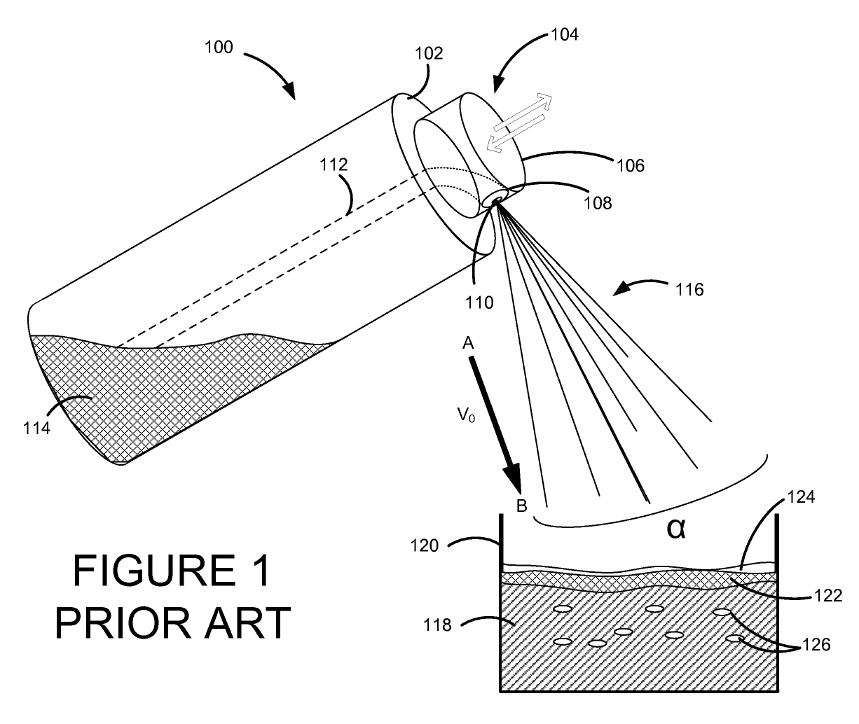

FIG. 1 is an illustration of a conventional liquid delivery system 100. The liquid delivery system 100 includes a container 102 for holding a certain volume of liquid. In some instances, the liquid may be a mixture or solution comprised of a sweetening component. The liquid delivery system 100 may also include a nozzle apparatus 104. The nozzle apparatus 104 may include a pump 106, a nozzle 108 and an exit port 110 in the nozzle 108. The liquid delivery system 100 may also include an intake tube 112.

To operate the liquid delivery system 100, a user (not pictured) may depress the pump 106. In some examples, the depression of the pump 106 may increase the internal pressure of the container 102, causing liquid 114 within the container to be expelled through the exit port 110 upon a release of the pump 106. In other examples, the depression of the pump 106 may decrease a pressure within the pump 106. When released, the decrease in pressure may be used to pull the liquid 114 through the intake tube 112 and be expelled through the exit port 110. It should be understood that these and other techniques for extracting the liquid 114 from the container 102 may be used, the presently disclosed subject matter not being limited to any particular technique.

When a portion 116 of the liquid 114 is expelled from the container 102 through the exit port 110, the portion 116 of the liquid 114 can travel generally along a path from A [symbol] B to a target liquid 118 in a container 120. In some examples, the portion 116 of the liquid 114 can have a mean velocity of V₀ and an arc length a as the portion 116 travels to the target liquid 118. It should be noted that in some instances, the portion 116 is comprised of droplets. The use of lines in FIG. 1 for the portion 116 is for purposes of illustration only and is not intended to indicate that the portion 116 is or has to be a solid stream of liquid.

In some examples, upper layers 122 of the target liquid 118 may have a surface tension or other properties that act as a partial barrier to the portion 116 of the liquid 114. Thus, when sprayed, a remaining portion 124 of the portion 116 of the liquid 114 may remain on top of the upper layers 122. Droplets 126 of the portion 116 of the liquid 114 may penetrate the upper layers 122 to mix with the target liquid 118. To move some of the remaining portion 124 into the target liquid 118, a user may have to mechanically agitate (or stir) the target liquid 118. In some examples, the need to stir may cause increased trash or refuse, as plastic or wooden stir sticks are often used.

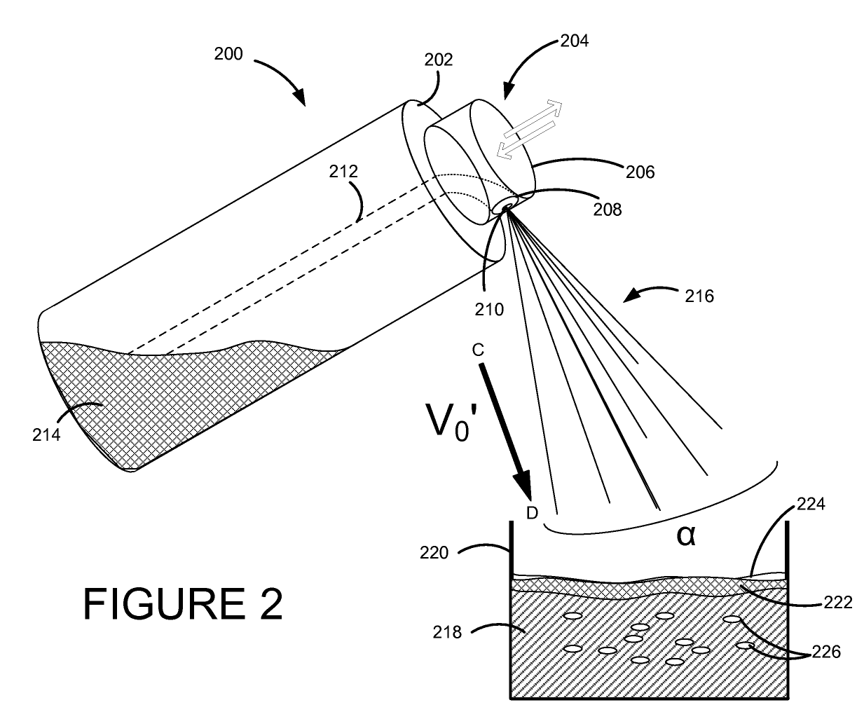

FIG. 2 is an illustration of a liquid delivery system 200 having an increased velocity. The liquid delivery system 200 includes a container 202 for holding a certain volume of liquid. In some instances, the liquid may be a mixture or solution comprised of a sweetening component. In some examples, the sweetening component may be: one or more artificial sweeteners such as Ace K, aspartame, neotme, saccharin, sucralose, or advantame; one or more sugar alcohols such as erythitol, isomalt, lactitol, maltitol, mannitol, sorbitol, xylitol, glycerine, or hydrogenated starch hydrolysate; natural sweeteners such as stevia and stevia extracts, tagatose, trehalose, agave nectar, date sugar, fruit juice concentrate, honey, maple syrup, molasses, sugar, or high fructose corn syrup; or combinations of various artificial sweeteners, sugar alcohols, and natural sweeteners. It should be noted that the listing of sweeteners is for purposes of example only and is not an intent to limit the scope of the presently disclosed subject matter to the sweeteners listed herein.

The liquid delivery system 200 may also include a nozzle apparatus 204. The nozzle apparatus 204 may include a pump 206, a nozzle 208 and an exit port 210 in the nozzle 208. The liquid delivery system 200 may also include an intake tube 212. To operate the liquid delivery system 200, a user (not pictured) may depress the pump 206. In some examples, the depression of the pump 206 may increase the internal pressure of the container 202, causing liquid 214 within the container to be expelled through the exit port 210 upon a release of the pump 206.

In other examples, the depression of the pump 206 may decrease a pressure within the pump 206. When released, the decrease in pressure may be used to pull the liquid 214 through the intake tube 212 and be expelled through the exit port 210. It should be understood that these and other techniques for extracting the liquid 214 from the container 202 may be used, the presently disclosed subject matter not being limited to any particular technique.

A portion 216 of the liquid 214 is expelled from the container 202 through the exit port 210. The portion 216 of the liquid 214 can travel generally along a path from C [symbol] D to a target liquid 218 in a container 220. As noted above, in some examples, top layers 222 of the target liquid 218 may have a relatively high surface tension. Thus, in some examples, a remaining portion 224 of the portion 216 of the liquid 214 may remain on top of the upper layers 222. Droplets 226 of the portion 216 of the liquid 214 may penetrate the upper layers 222 to mix with the target liquid 218.

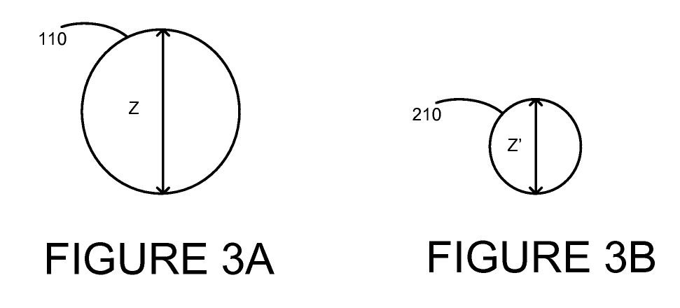

To reduce the amount of the remaining portion 224, and to increase the amount of mixing without mechanical agitation, in some examples, the nozzle apparatus 204 may be configured to increase the velocity V₀′ of the portion 216 of the liquid 214. Increasing the velocity V₀′ may increase the force at which the portion 216 of the liquid 214 impacts the top layers 222. The increased force may allow some or all of the portion 216 to move through the top layers 222 and enter the target liquid 218 in an amount greater than what may be achieved with the velocity V₀ of the liquid delivery system 100 of FIG. 1. The velocity V₀′ may be adjusted using various technologies. For example, the diameter of the exit port 210 may be reduced, as illustrated in further detail in FIGS. 3A and 3B.

In FIG. 3A, the exit port 110 of FIG. 1 is shown. The exit port 110 has an internal diameter of Z. In FIG. 3A, the exit port 210 of FIG. 2 is shown. The exit port 210 has an internal diameter of Z′. In some examples, maintaining other factors constant, having a reduced diameter (e.g. from Z to Z′) may increase the velocity of liquid exiting the exit port 210 from V₀ to V₀′.

Returning to FIG. 2, in some examples, the increased in velocity from V₀ to V₀′ can cause a reduction in the amount of liquid in the remaining portion 224 as compared to the remaining portion 124 of FIG. 1. Because the amount of liquid in the remaining portion 224 is reduced, the amount of droplets 226 of the portion 216 of the liquid 214 that penetrate the upper layers 222 to mix with the target liquid 218 may be increased.

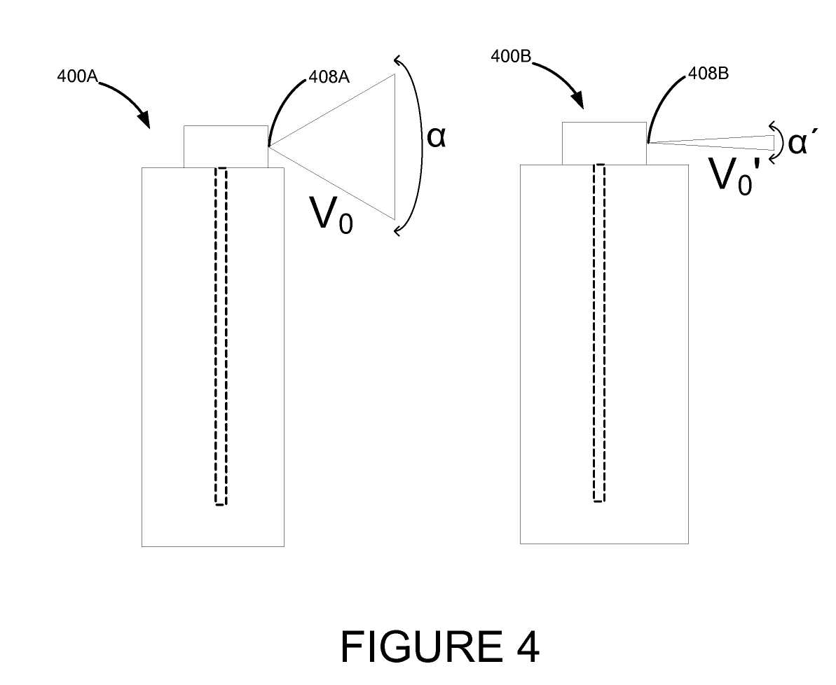

FIG. 4 are side view illustrations of a liquid delivery system 400A and a liquid delivery system 400B having different exit angles. In FIG. 4, the liquid delivery system 400A has the exit port 110 of FIG. 1, resulting in the liquid 114 exiting the exit port of V₀ and an exit angle α. The liquid delivery system 400B has the exit port 210 of FIG. 2, resulting in the liquid 214 exiting the exit port of V₀′ and an exit angle α′. As can be seen in FIG. 4, the increased velocity can reduce the exit angle. In some examples, exit angles may vary from approximately 0 degrees to approximately 135 degrees.

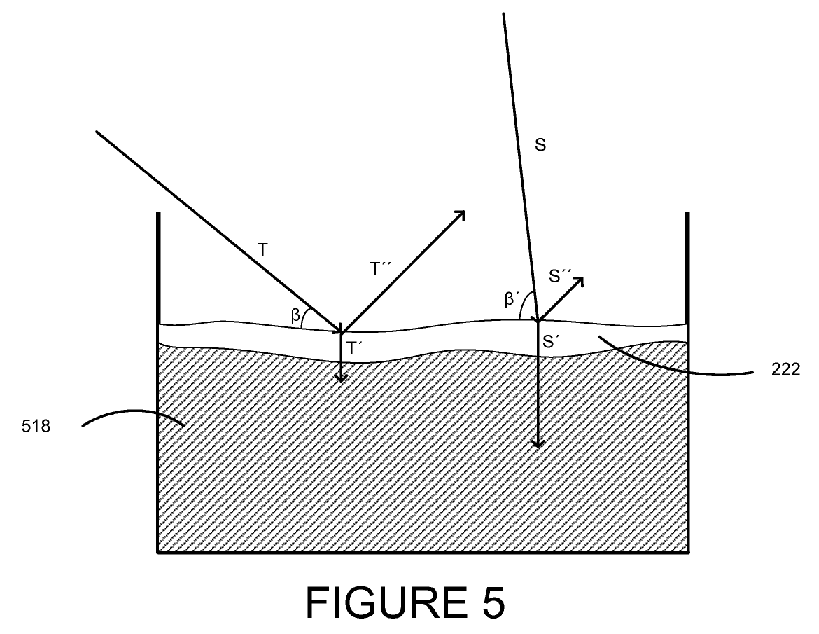

A reduced exit angle may also increase the mixing of the liquid 214, as more of the liquid 214 impinging a target liquid strikes the liquid closer to a perpendicular orientation with respect to the surface of the target liquid. Striking the liquid closer to a perpendicular orientation may increase the probability that a portion of the liquid enters the target liquid past a top layer, illustrated in further detail in FIG. 5.

As noted above, in some examples, exit angles may vary from approximately 0 degrees to approximately 135 degrees. The exit angle may vary depending on the particular use of the liquid delivery system. For example, the liquid delivery system 400A may provide a greater coverage area, but at a lower exit velocity, for the same volumetric output as compared to the liquid delivery system 400B, which may provide a relatively smaller coverage area but at a relatively higher velocity. In some examples, a relatively larger coverage area may be more preferable when using a liquid delivery system on foods such as popcorn. In other examples, a relatively higher velocity may be more preferable when using a liquid delivery system for liquids such as coffee.

In further examples, a single liquid delivery system may be adjustable to provide a spray pattern of varying exit angles. For example, the liquid delivery system 400A and the liquid delivery system 400B may be the same liquid delivery systems. However, the liquid delivery system 400A may have a nozzle adjustment to provide an exit angle that is greater than the liquid delivery system 400B configuration. The exit angle, in some implementations, may be adjustable from about 0 degrees to about 135 degrees, and at various angles in between. In some uses, a single liquid delivery system may be used for multiple purposes by adjusting the exit angle of the liquid delivery system.

FIG. 5 is a side view illustration showing different impact angles of a liquid. In FIG. 5, a vector T and a vector S are illustrated as impacting a top surface 522 of a target liquid 518. The vector T represents a portion of a liquid striking the top surface 522 at an incidence angle β. The vector S represents a portion of a liquid striking the top surface 522 at an incidence angle β′. Upon striking the top surface 522, the liquid of vector T may be modified into vector T′ and vector T″.

Vector T′ represents the liquid that has a force perpendicular or downward into target liquid 518 and vector T″ is a vector representing the remaining portion of the liquid. In a similar manner, upon striking the top surface 522, the liquid of vector S may be modified into vector S′ and vector S″. Vector S′ represents the liquid that has a force perpendicular or downward into target liquid 518 and vector S″ is a vector representing the remaining portion of the liquid. It should be noted that angles and magnitudes illustrated in FIG. 5 are merely exemplary.

Assuming that the magnitude of the vector T and the vector S are equal and that incidence angle β is less than incidence angle β′, it can be seen that the vector T′ is less than the vector S′. In some examples, a larger vector from the vector T′ to the vector S′ may increase the amount of the liquid that enters the target liquid 518.

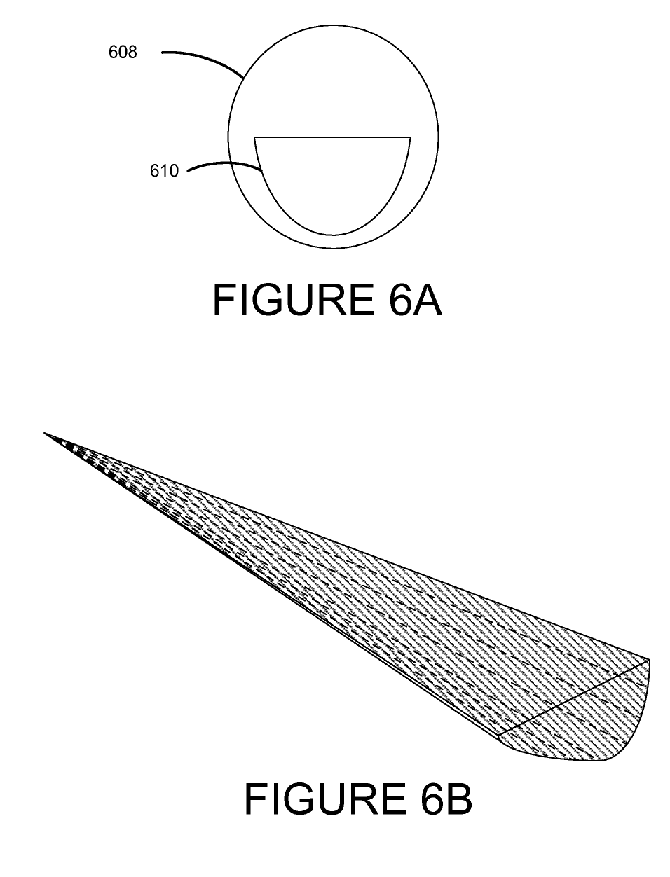

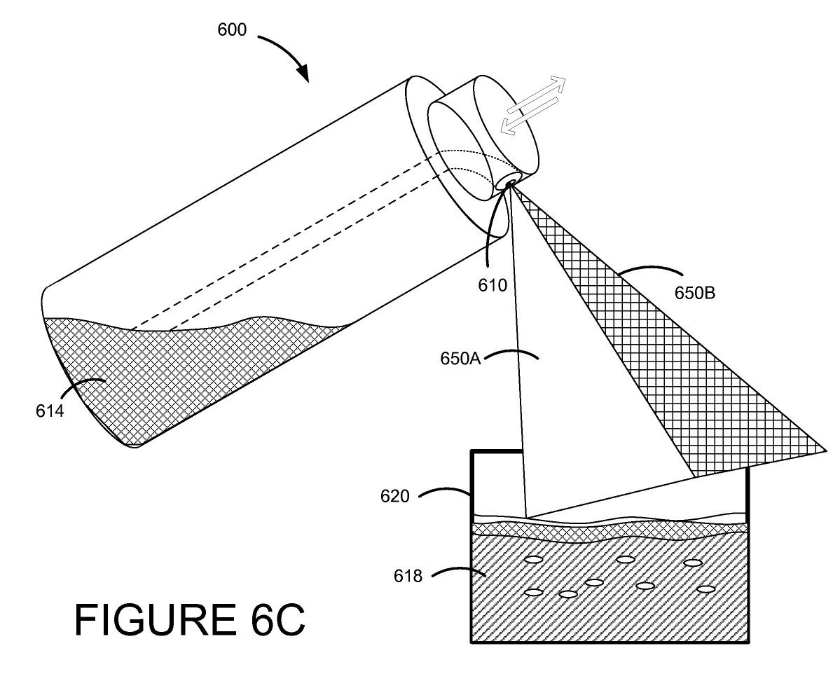

FIG. 6A is an illustration showing an alternative nozzle 608 configured to provide a modified spray pattern. As shown in FIG. 6A, the nozzle 608 includes an exit port 610. The exit port 610 is modified from a circular shape to a semi-circular shape. As noted above with respect to FIG. 1, in some uses, a liquid delivery system may be used to introduce a sweetened liquid into a container such as a cup or bowl. If the cup or bowl is of a certain size in relation to the spray pattern, some of the spray may end up on the container or may be sprayed outside of the container, wasting at least a portion of the liquid sweetener. To reduce or eliminate this waste, the exit port 610 has been modified to be in a semi-circular shape. The semi-circular shape of the exit port may cause a semi-circular spray pattern, as illustrated in FIG. 6B.

FIG. 6C is an illustration showing a liquid delivery system 600 using the exit port 610. The semi-circular shape of the exit port 610 modifies the spray pattern from including both spray 650A and 650B to including only spray 650A of the liquid 614. As can be seen in FIG. 6C, spray 650B impinges a side of the container 620 and travels outside of the container 620, wasting at least a portion of the spray 650B. The shape of the exit port 610 can be modified in other shapes, the variations of which are considered to be within the scope of the presently disclosed subject matter.

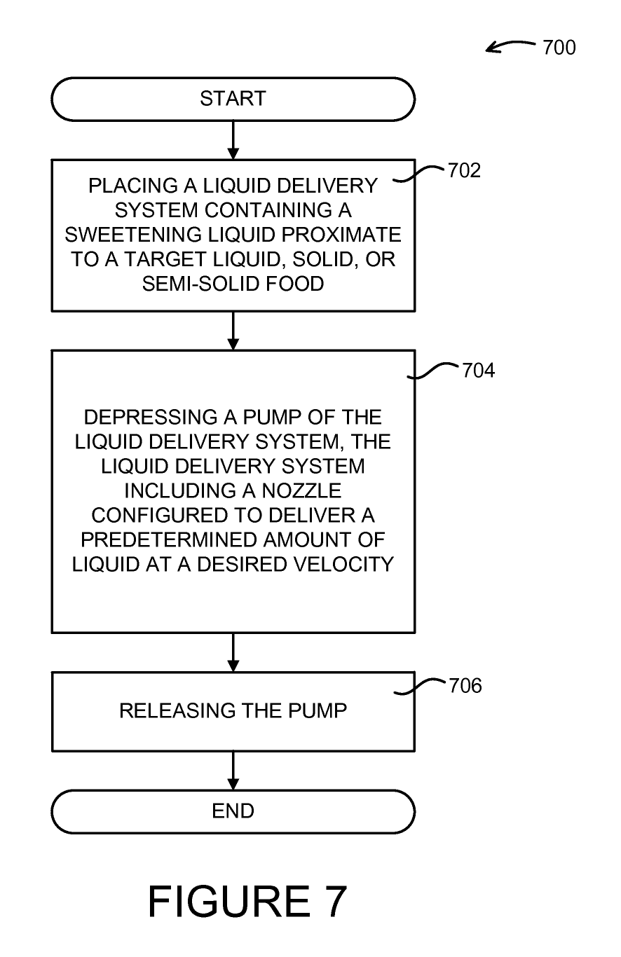

FIG. 7 illustrates one configuration of a routine 700 for using a liquid delivery system, according to at least one embodiment disclosed herein. Unless otherwise indicated, more or fewer operations may be performed than shown in the figures and described herein. Additionally, unless otherwise indicated, these operations may also be performed in a different order than those described herein.

The routine 700 commences at operation 702 (“placing a liquid delivery system containing a sweeting liquid proximate to a target liquid”), where a user may place a liquid delivery system containing a sweeting liquid proximate to a target liquid. For example, a user may place the liquid delivery system proximate to a coffee cup or other liquid. In another example, a user may place the liquid delivery system proximate to vegetables, fruits, breads, nuts, or other types of food.

The routine 700 continues to operation 704 (“depressing a pump of the liquid delivery system, the liquid delivery system including a nozzle configured to deliver a predetermined amount of liquid at a desired velocity”), where a user depresses a pump of a liquid delivery system, the liquid delivery system including a nozzle configured to deliver a predetermined amount of liquid at a desired velocity. In some examples, an exit angle may be a factor rather than, or included with, the desired velocity. The desired velocity may be a velocity to increase the probability that a portion of the liquid will move through a top layer of a target liquid having a surface tension. In some examples, the liquid may comprise a sweetening component.

The routine 700 may continue to operation 706 (“releasing the pump”), where the user may release the pump. The routine 700 may thereafter end.

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

What is claimed is:

1. A liquid delivery system, comprising:
a container for holding a certain volume of liquid, the liquid comprising a sweetening component; and
a nozzle apparatus, the nozzle apparatus comprising
a pump configured to cause the liquid to be pulled through an intake tube,
a nozzle, and
an exit port, wherein the exit port is sized and shaped to cause the liquid to exit the exit port in spray pattern at a desired velocity.

2. The liquid delivery system of claim 1, wherein the desired velocity increases the probability that a portion of the liquid will move through a top layer of a target liquid having a surface tension.

3. The liquid delivery system of claim 1, wherein the sweetening component comprises an artificial sweetener, a sugar alcohol, a natural sweetener, or combinations thereof.

4. The liquid delivery system of claim 3, wherein the artificial sweetener comprises Ace K, aspartame, neotme, saccharin, sucralose, advantame, or combinations thereof.

5. The liquid delivery system of claim 3, wherein the sugar alcohol comprises erythitol, isomalt, lactitol, maltitol, mannitol, sorbitol, xylitol, glycerine, hydrogenated starch hydrolysate, or combinations thereof.

6. The liquid delivery system of claim 3, wherein the natural sweetener comprises stevia, stevia extracts, tagatose, trehalose, agave nectar, date sugar, fruit juice concentrate, honey, maple syrup, molasses, sugar, high fructose corn syrup, or combinations thereof.

7. A method of using a liquid delivery system, the method comprising:
placing the liquid delivery system containing a sweetening liquid proximate to a target liquid, solid food, or semi-solid food;
depressing a pump of the liquid delivery system to cause the sweetening liquid to be pulled through an intake tube and exit from an exit port at a desired velocity, wherein the exit port is sized and shaped to cause the liquid to exit the exit port at the desired velocity; and
releasing the pump.

8. The method of claim 7, wherein the desired velocity increases the probability that a portion of the liquid will move through a top layer of a target liquid having a surface tension.

9. The method of claim 7, wherein the sweetening component comprises an artificial sweetener, a sugar alcohol, a natural sweetener, or combinations thereof.

10. The method of claim 9, wherein the artificial sweetener comprises Ace K, aspartame, neotme, saccharin, sucralose, advantame, or combinations thereof.

11. The method of claim 9, wherein the sugar alcohol comprises erythitol, isomalt, lactitol, maltitol, mannitol, sorbitol, xylitol, glycerine, hydrogenated starch hydrolysate, or combinations thereof.

12. The method of claim 9, wherein the natural sweetener comprises stevia, stevia extracts, tagatose, trehalose, agave nectar, date sugar, fruit juice concentrate, honey, maple syrup, molasses, sugar, high fructose corn syrup, or combinations thereof.

13. A liquid delivery system, comprising:
a container for holding a certain volume of liquid, the liquid comprising a flavoring component; and
a nozzle apparatus, the nozzle apparatus comprising
a pump configured to cause the liquid to be pulled through an intake tube,
a nozzle, and
an exit port, wherein the exit port is sized and shaped to cause the liquid to exit the exit port in spray pattern at a desired velocity.

14. The liquid delivery system of claim 13, wherein the exit port is modifiable to change an exit angle.

15. The liquid delivery system of claim 14, wherein the exit angle ranges from approximately 0 degrees to approximately 135 degrees.

16. The liquid delivery system of claim 13, wherein the flavoring component comprises a fruit flavoring, a bacon flavoring, a meat flavoring, a vegetable flavoring, a spice, an herb, chocolate, vanilla, or salt, or various combinations thereof.
